(19) United States
(12) Patent Application Publication
(10) Pub. No.: US 2015/0199186 A1
(43) Pub. Date: Jul. 16, 2015

(54) IMPLEMENT INLINE CACHE USING A DATA ARRAY

(71) Applicant: GOOGLE INC., Mountain View, CA (US)

(72) Inventors: Srjdan MITROVIC, Atherton, CA (US); Kasper Verdich LUND, Aarhus C (DK); Ivan POSVA, Mountain View, CA (US)

(73) Assignee: GOOGLE INC., Mountain View, CA (US)

(21) Appl. No.: 13/648,128

(22) Filed: Oct. 9, 2012

Related U.S. Application Data
(60) Provisional application No. 61/544,845, filed on Oct. 7, 2011.

(51) Int. Cl. G06F 9/45

(52) U.S. Cl. CPC G06F 8/443

(57) ABSTRACT

Methods and systems are provided for implementing an inline cache that uses a data array to perform receiver class checks. The data array contains classes, targets, and counters. The invocation is forwarded to the appropriate target when the checked class matches. On the other hand, an inline cache miss expands the data array with the new receiver class. The inline cache stub counts the invocations for specific classes and stores the count into the data array. The optimizing compiler can generate better code using the call type frequency (e.g., sort checks, limit the number of checks to the most frequently used classes, etc.).

The present application claims priority to U.S. Provisional Patent Application Ser. No. 61/544,845, filed Oct. 7, 2011, the entire disclosure of which is hereby incorporated by reference.

### TECHNICAL FIELD

The present disclosure generally relates to systems and methods for processing data. More specifically, aspects of the present disclosure relate to performing receiver class checks using inline caching.

### BACKGROUND

A virtual machine (VM) may implement a two-tiered compilation system comprising a basic compiler and an optimizing compiler. The basic compiler runs first and also collects types (e.g., type-feedback). The optimizing compiler compiles frequently executed methods to optimized code using the type feedback collected by the basic compiler.

Dynamic invocations of methods can be sped up by using inline caching. Inline caching may also be used to collect type feedback. An inline cache compares the receiver's class with a set of previously encountered classes and dispatches program execution to the matching target. Common implementation of inline caches generates assembly code to check classes and to jump to targets. A VM may be implemented for one or more programming languages (e.g., Dart, which is an open source Web programming language).

### SUMMARY

This Summary introduces a selection of concepts in a simplified form in order to provide a basic understanding of some aspects of the present disclosure. This Summary is not an extensive overview of the disclosure, and is not intended to identify key or critical elements of the disclosure or to delineate the scope of the disclosure. This Summary merely presents some of the concepts of the disclosure as a prelude to the Detailed Description provided below.

One embodiment of the present disclosure relates to a method for implementing an inline cache using a data array to perform receiver class checks, the method comprising: obtaining a class for a receiver; determining whether the class is in the data array; responsive to determining that the class is in the data array, obtaining a corresponding target for the class from the data array; incrementing a class counter in the data array; and calling the corresponding target.

In another embodiment of the disclosure, the method for implementing an inline cache further comprises: responsive to determining that the class is absent in the data array, expanding the data array with a new receiver class; and calling the corresponding target; and calling the corresponding target.

In yet another embodiment of the disclosure, the step of expanding the data array with a new receiver class in the method for implementing an inline cache includes computing the corresponding target for the class, and adding a new entry to the data array, the new entry containing the class and the corresponding target for the class.

Furthermore, one or more embodiments of the methods and systems described herein may optionally include one or more of the following additional features: an inline cache stub counts invocations for specific classes and stores the count into the data array; and/or the data array contains classes, targets, and counters.

Further scope of applicability of the present disclosure will become apparent from the Detailed Description given below. However, it should be understood that the Detailed Description and specific examples, while indicating preferred embodiments, are given by way of illustration only, since various changes and modifications within the spirit and scope of the invention will become apparent to those skilled in the art from this Detailed Description.

### BRIEF DESCRIPTION OF DRAWINGS

These and other objects, features and characteristics of the present disclosure will become more apparent to those skilled in the art from a study of the following Detailed Description in conjunction with the appended claims and drawings, all of which form a part of this specification. In the drawings:

FIG. 1 is a flowchart illustrating an example process for implementing an inline cache using a data array to perform receiver class checks according to one or more embodiments described herein.

The headings provided herein are for convenience only and do not necessarily affect the scope or meaning of the claimed invention.

In the drawings, the same reference numerals and any acronyms identify elements or acts with the same or similar structure or functionality for ease of understanding and convenience. The drawings will be described in detail in the course of the following Detailed Description.

### DETAILED DESCRIPTION

Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention can include many other obvious features not described in detail herein. Additionally, some well-known structures or functions may not be shown or described in detail below, so as to avoid unnecessarily obscuring the relevant description.

The present disclosure presents methods and systems for implementing an inline cache that uses a data array to perform receiver class checks. In at least one embodiment, the data array contains classes, targets, and counters. As will be described in greater detail herein, the invocation may be forwarded to the appropriate target when the checked receiver's class matches an entry in the data array.

In one or more embodiments, an inline cache miss expands the data array with the new receiver class. The inline cache stub counts the invocations for specific classes and stores the count into the data array. The optimizing compiler can generate better code using the call type frequency (e.g., sort checks, limit the number of checks to the most frequently used classes, etc.). The performance penalty is negligible since the optimized code does not use inline caches.

According to at least one embodiment of the present disclosure, the solution proposed herein may collect type feedback without decreasing performance of running programs. This collected type feedback may occur in, for example, sharable code stubs, thus decreasing code size. Furthermore, the collected type feedback information may be enhanced with invocation frequency, thus allowing better code generation by the optimizing compiler.

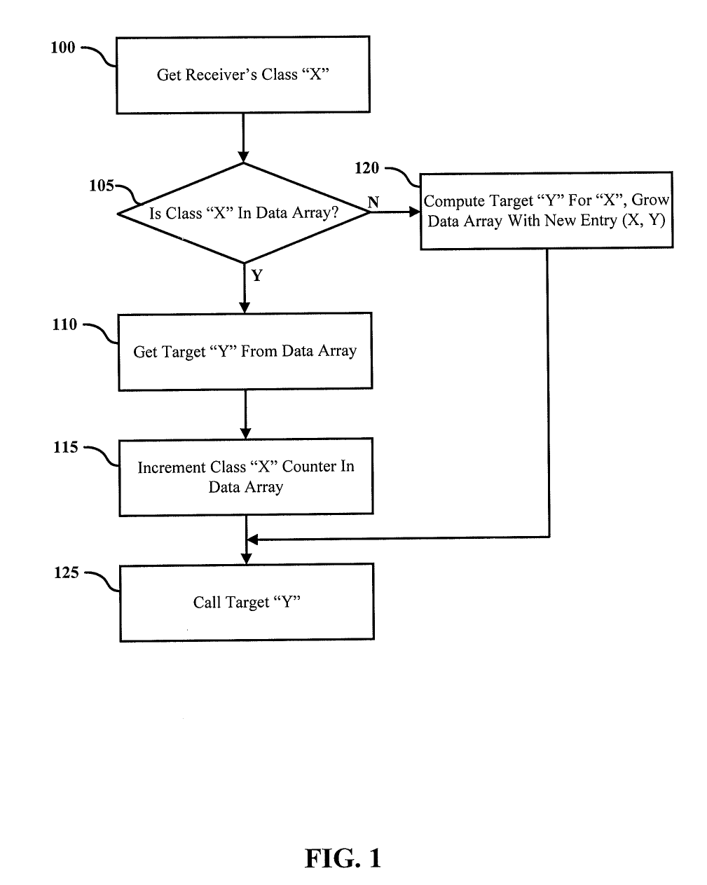

An example process according to at least one embodiment will be described with reference to FIG. 1. The process illustrated in FIG. 1 may be implemented, for example, at a dynamic call to a target “Y”, which is determined at runtime using the receiver's class “X”. Each dynamic call has its own data array.

The process begins at step 100, where the receiver's class “X” is obtained. In step 105, a determination is made as to whether class “X” is in the data array. If it is found in step 105 that class “X” is in the data array, then the process moves to step 110 where target “Y” is obtained from the data array. On the other hand, if it is determined in step 105 that class “X” is not in the data array, then the process goes to step 120, where target “Y” is computed for class “X” and a new entry (X, Y) is added to the data array.

Once target “Y” is obtained from the data array in step 110, the process continues to step 115 where the class “X” counter in the data array is incremented accordingly. The process then moves to step 125 where target “Y” is called.

The following is an example pseudo code that may be used in accordance with at least one embodiment of the disclosure:

```
class Check {
  Check(Class this.checkClass, Function this.target) : count = 0 { }
  Class checkClass;
  Function target;
  int count;
}
void dispatch (Object rcv, List<Check> data, String methodName) {
  Class receiverClass = rcv.class;
  // Check inline cache.
  for (Check elem in data) {
    if (elem.checkClass == receiverClass) {
      elem.count++;
      JumpTo (elem.target);
    }
  }
// Inline cache miss: Lookup method and update cache.
Function target = lookupMethod (receiverClass, methodName);
data.add (new Check (receiverClass, target));
JumpTo (target);
}
object.foo( ) ->
static List<Check>DATA = new List<Check>( );
dispatch (object, DATA, “foo”);
```

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A computer-implemented method for implementing an inline cache using a data array to perform receiver class checks, the method comprising:
obtaining a class for a receiver;
determining whether the class is in the data array;
responsive to determining that the class is in the data array, computing a corresponding target for the class using data collected at a call site associated with the data array;
incrementing a class counter in the data array; and
calling the corresponding target.

2. The method of claim 1, further comprising:
responsive to determining that the class is absent in the data array, expanding the data array with a new receiver class; and
calling the corresponding target.

3. The method of claim 2, wherein expanding the data array with the new receiver class includes:
computing the corresponding target for the class using data collected at the call site associated with the data array; and
adding a new entry to the data array, the new entry containing the class and the corresponding target for the class.

4. The method of claim 1, wherein an inline cache stub counts invocations for specific classes and stores the count into the data array.

5. The method of claim 1, wherein the data array contains classes, targets, and counters.

6. The method of claim 1, wherein the data collected at the call site includes type feedback information for an optimizing compiler.

7. The method of claim 6, wherein the type feedback information includes runtime type of at least one argument of the call.

8. The method of claim 1, wherein the data collected at the call site includes call type frequency.

9. The method of claim 8, wherein the collected call type frequency is used for triggering optimizations and computing optimal sorting of basic blocks.
